(19) United States
(12) Patent Application Publication
(10) Pub. No.: US 2024/0362412 A1
(43) Pub. Date: Oct. 31, 2024

(54) ENTROPY BASED KEY-PHRASE EXTRACTION

(71) Applicant: Microsoft Technology Licensing, LLC, Redmond, WA (US)

(72) Inventors: Alexander TSVETKOV, Tel Aviv (IL); Abed El Kader ASI, Sammamish, WA (US); Royi RONEN, Tel Aviv (IL); Dean GECKT, Haifa (IL); Roy EISENSTADT, Tel Aviv (IL)

(21) Appl. No.: 18/306,744

(22) Filed: Apr. 25, 2023

(51) Int. Cl. G06F 40/284; G06F 40/289

(52) U.S. Cl. CPC G06F 40/284; G06F 40/289

(57) ABSTRACT

Example solutions for performing key phrase extraction from content items using a large language model (LLM) include: determining a token entropy score for a first token of a content item containing text content by generating and submitting a prompt to the LLM, that includes prefix tokens preceding a first token, receiving a probability distribution from the LLM, and generating a token entropy score for the first token; identifying a candidate phrase that includes one or more tokens, each token having an associated token entropy score; computing a phrase entropy score for the candidate phrase based on the token entropy scores of the one or more tokens; storing the candidate phrase as a key phrase of the content item upon the phrase entropy score exceeding a threshold; and searching a database of content items based on the key phrase, the search returning results including the content item.

### BACKGROUND

Many organizations have content, such as documents or media, that cannot be easily indexed, annotated, searched, or tracked. Further, it is difficult to identify key phrases within the content using existing computerized techniques.

### SUMMARY

The disclosed examples are described in detail below with reference to the accompanying drawing figures listed below. The following summary is provided to illustrate some examples disclosed herein. The following is not meant, however, to limit all examples to any particular configuration or sequence of operations.

Example solutions for performing key phrase extraction from content items using a large language model (LLM) include: identifying a content item comprising text content; determining a token entropy score for a first token of the content item by: generating and submitting a prompt to a large language model (LLM), the prompt including a prefix token preceding the first token of the text content; receiving a probability distribution from the LLM in response to the prompt; and generating a token entropy score for the first token; identifying a candidate phrase within the text content, the candidate phrase including a first token; computing a phrase entropy score for the candidate phrase based on the token entropy score of the first token; storing the candidate phrase as a key phrase of the content item upon the phrase entropy score exceeding a threshold; and searching a database of content items based on the key phrase, the search returning results including the content item.

### BRIEF DESCRIPTION OF THE DRAWINGS

The disclosed examples are described in detail below with reference to the accompanying drawing figures listed below:

FIG. 1 illustrates an example architecture that advantageously uses a large language model (LLM) to identify key phrases within text content;

FIG. 2 is a dataflow diagram illustrating an example method for generating token entropy scores for each of the tokens (words) of the text document using an example architecture, such as the example architecture shown in FIG. 1;

FIG. 3 is a dataflow diagram illustrating an example method for identifying candidate phrases and candidate phrase entropy scores from the text content of text document using stop words;

FIG. 4 is a dataflow diagram illustrating another example method for identifying candidate phrases and candidate phrase entropy scores from the text of text document using a sliding window approach;

FIG. 5 is a flowchart illustrating exemplary operations that may be performed by architecture for providing key-phrase extraction and entropy evaluation of key phrases; and

FIG. 6 is a block diagram of an example computing device (e.g., a computer storage device) for implementing aspects disclosed herein, and is designated generally as a computing device.

Corresponding reference characters indicate corresponding parts throughout the drawings. Any of the drawings may be combined into a single example or embodiment.

### DETAILED DESCRIPTION

It can be difficult for many organizations to organize and utilize related content, such as documents, emails, voicemails, conference call recordings, or the like. For example, an organization has various client interactions that are memorialized in different types of content, such as emails, voicemails, conference call recordings, written notes from customer interactions or sales calls, or the like. Such content types contain natural language content that may natively exist in digital text form (e.g., text emails, text messages, customer interaction log files) or that may be converted into digital text form (e.g., voice content such as voicemails or conference call recordings). This text content can then be analyzed for important words or phrases, also referred to herein as “key words” or “key phrases,” which can then be used to index and organize the various content items, summarize content of text, and identify the main topics discussed.

There are several known key-phrase extraction algorithms that attempt to identify such key phrases within text content. One family of key-phrase extraction methods identifies key phrases based on semantic similarity. KeyBERT is one such algorithm. KeyBERT is an open-source Python library that relies on BERT (Bidirectional Encoder Representations from Transformers) embeddings to capture key phrases from text. BERT is a family of masked-language models that learn latent representations of words and sentences. Another family of key-phrase extraction algorithms is based on statistical aspects of text. RAKE (Rapid Automatic keyword Extraction), YAKE! (Yet Another Keyword Extractor), and TF-IDF (Term Frequency-Inverse Document Frequency) are several such examples. Such algorithms rely upon phrases that are most similar to all of a text, and extract phrases that have the most semantic similarity to the text or are based on statistic and relationships between the words within the text. However, these existing solutions fail to capture some types of key phrases, as they use the properties only of the existing text.

In contrast, the example solutions described herein use large language models (LLMs) such as GPT family of LLMs (GPT-2, GPT-3, GPT-4, made publicly available as ChatGPT by OpenAI) or the like. LLMs are artificial intelligence (AI) system that are designed to understand and generate human language inputs and outputs. LLMs are typically built using deep learning techniques, specifically a type of neural network called a transformer model, which is trained on vast amounts of text data. The training process for an LLM involves exposing it to massive amounts of natural language data, such as books, articles, and web pages, and allowing the LLM to learn the underlying patterns and structures of language. This training process typically uses a large amount of computing power and sophisticated algorithms, which are typically provided by specialized machine learning platforms like Google Cloud AI, OpenAI, or Amazon Web Services (AWS). Once trained, LLMs can be used for a wide range of language-related tasks, including language translation, summarization, question-answering, text generation, and sentiment analysis. They are also increasingly being used in natural language processing (NLP) applications, such as chatbots, virtual assistants, and content moderation systems. LLMs have numerous benefits, including the ability to process and generate vast amounts of text data quickly and accurately. LLMs can also learn from new data and improve over time, making them increasingly effective as they are used more frequently.

Because LLMs encode the distribution of natural language (e.g., English) from a large corpus of text, LLMs have the ability to assess saliency based on the entirety of the trained language and context, not merely just on the text of a document itself. Example solutions use LLMs to assess the “informativeness” of phrases within the text, such as by evaluating an entropy measure of words or phrases found within text. In information theory, entropy quantifies the amount of information or uncertainty inherent to a variable's possible outcomes. The probability of a phrase in lieu of a given prefix is inversely proportional to its entropy. In other words, a phrase with higher probability of occurring given a particular prefix indicates that the level of informativeness or entropy of that phrase is low. Similarly, a phrase with a low probability indicates that the phrase has high entropy.

A key-phrase extraction engine determines entropy scores of each token (word) of text by submitting prompts to an LLM for evaluation using tokens preceding a particular word. The LLM outputs a probability distribution of a next token based on previous tokens. This probability distribution is used to calculate an entropy score for each candidate phrase. The key-phrase extraction engine uses the entropy scores of the various candidate phrases to identify the most informative key phrases, or the key phrases with the highest entropy. These key phrases are then linked to the underlying document and may be used as an index in various use cases, such as document annotation, organization, search, clustering, or the like.

Example solutions use large language models (LLMs) to evaluate the entropy of phrases within text-based content. The example solutions described herein have several practical applications and technical advantages over existing approaches. The use of LLMs to evaluate phrase probabilities to identify high entropy phrases allows the identification of key phrases that may not be detected by conventional approaches. Since LLMs are trained on a massive corpus of text and preconfigured to evaluate token probability relative to prefix text, these example solutions leverage the probability evaluations in an evaluation of entropy to identify the most informative key phrases within text. Thus, the present disclosure implements LLMs in novel ways to provide technical advantages in the field of key phrase extraction and document management, allowing LLM output to be used in computing entropy scores for key phrases that can then be used for searching those content items or various other document management purposes.

The various examples are described in detail with reference to the accompanying drawings. Wherever preferable, the same reference numbers is used throughout the drawings to refer to the same or like parts. References made throughout this disclosure relating to specific examples and implementations are provided solely for illustrative purposes but, unless indicated to the contrary, are not meant to limit all examples.

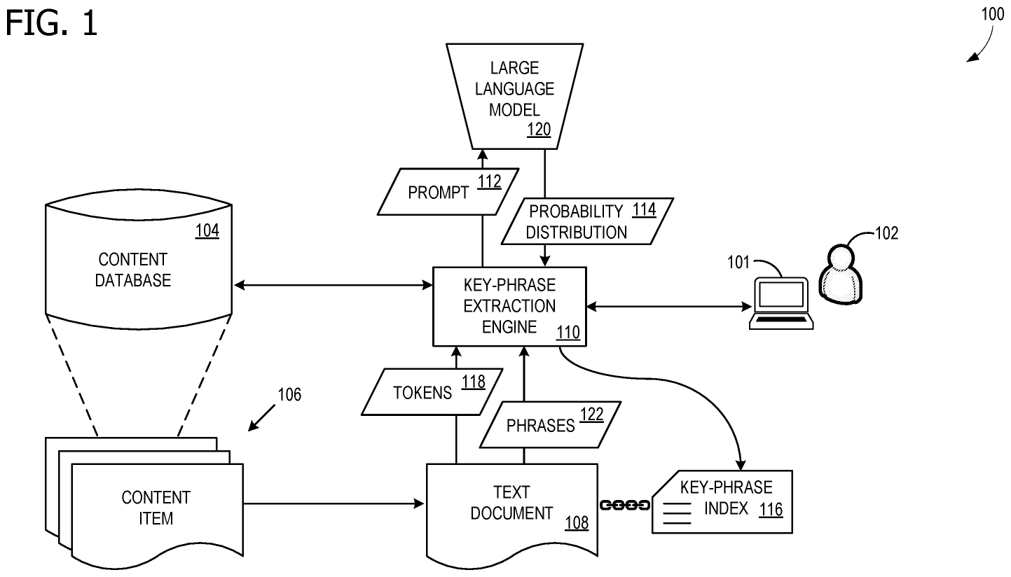

FIG. 1 illustrates an example architecture 100 that advantageously uses a LLM 120 to identify key phrases within text content. In architecture 100, a user 102 at a user computing device 101 interacts with a key-phrase extraction engine (“KP engine”) 110 to perform key-phrase extraction on text-based content from a content database 104. The KP engine 110 is configured to analyze natural language (e.g., text) content from text components of content items 106, such as digital documents (e.g., word processing documents, web-based documents, PDF text, scientific articles, or the like), email or text messages, voice mail messages or video recording content (e.g., text generated from speech-to-text conversion), or the like. The KP engine 110 uses the LLM 120 to analyze this text content for key phrases with high entropy (e.g., high “informativeness”) within the document 108. The key phrases with the highest entropy are then stored as a key-phrase index 116, serving as metadata for the particular content item 106 within the content database 104. While some examples provided herein are given in the context of customer relationship management (CRM), and in the English language, it should be understood that the systems and methods described herein can be configured to support any text-based content in any natural language.

During operation, the KP engine 110 identifies a particular content item 106 for key-phrase analysis. In the example of FIG. 1, the content item 106 identified for analysis is a text document 108. The KP engine 110 operates on the subject text-based content of the content item 106, which is treated as a sequence of tokens (e.g., words) 118, some or all of which may have an ordered relationship within the text. The subject text content is described herein as tokens, 118 where each word is a token 118. For example, a sentence of text includes an ordered sequence of tokens 118 representing the words of the sentence.

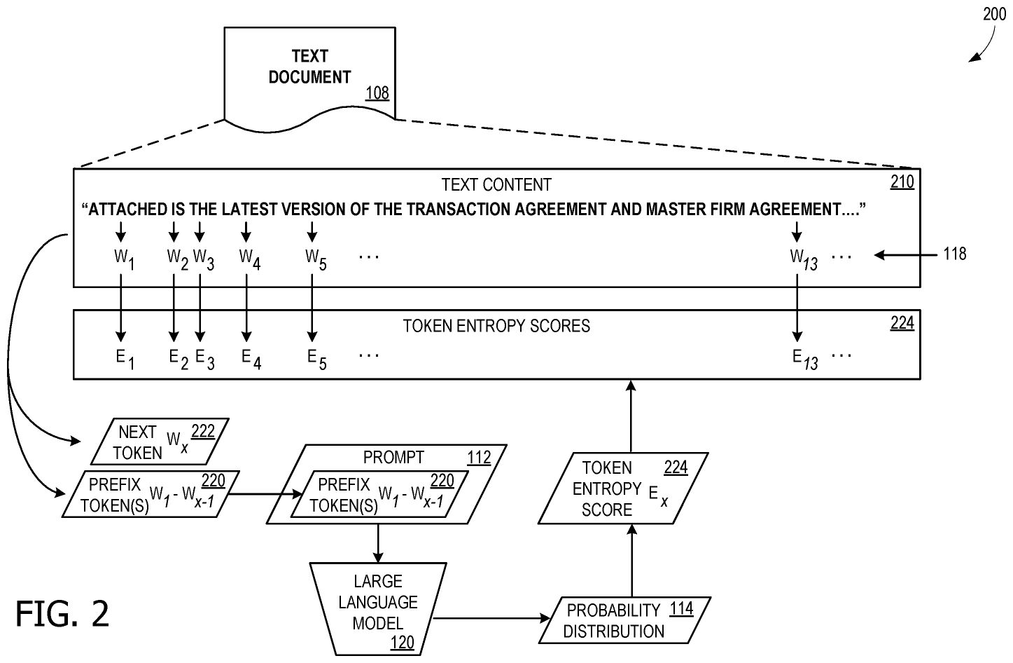

Further, portions of the text are also referred to herein as phrases. Each phrase can include one or more words, or one or more tokens 118. The KP engine 110 uses the LLM 120 to generate an entropy score for each word (token 118) in the document 108. More specifically, to evaluate the entropy of a particular token 118, the KP engine 110 generates a prompt 112 for submission to the LLM 120. The prompt 112 includes some or all of the preceding words (“prefix text”) and is configured to cause the LLM 120 to generate a probability distribution 114 in response. The probability distribution 114 identifies likelihoods of each word in a natural language vocabulary appearing after the given prefix text (e.g., a probability of each particular word appearing as the next word after the preceding text). The KP engine 110 uses this probability distribution 114 to generate an entropy score (a “token entropy score” or “token entropy value”) for that particular token 118. Likewise, the KP engine 110 generates a prompt 112 for each token 118 as it appears in the text document 108 and uses the resulting probability distributions 114 to generate token entropy scores for each of the individual tokens 118 of the document 108. The token entropy scoring process is described in greater detail below with respect to FIG. 2.

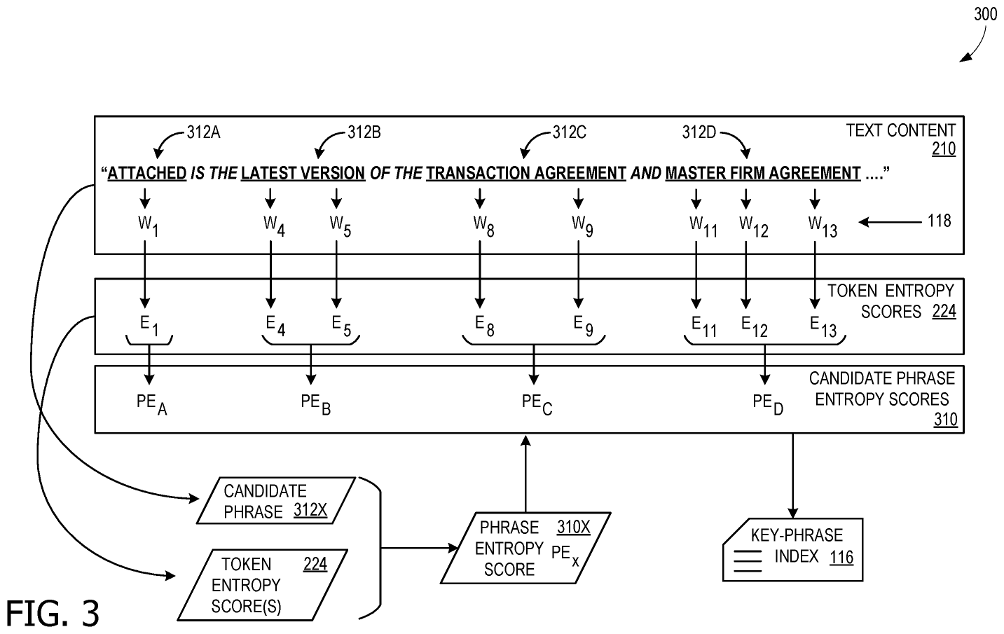

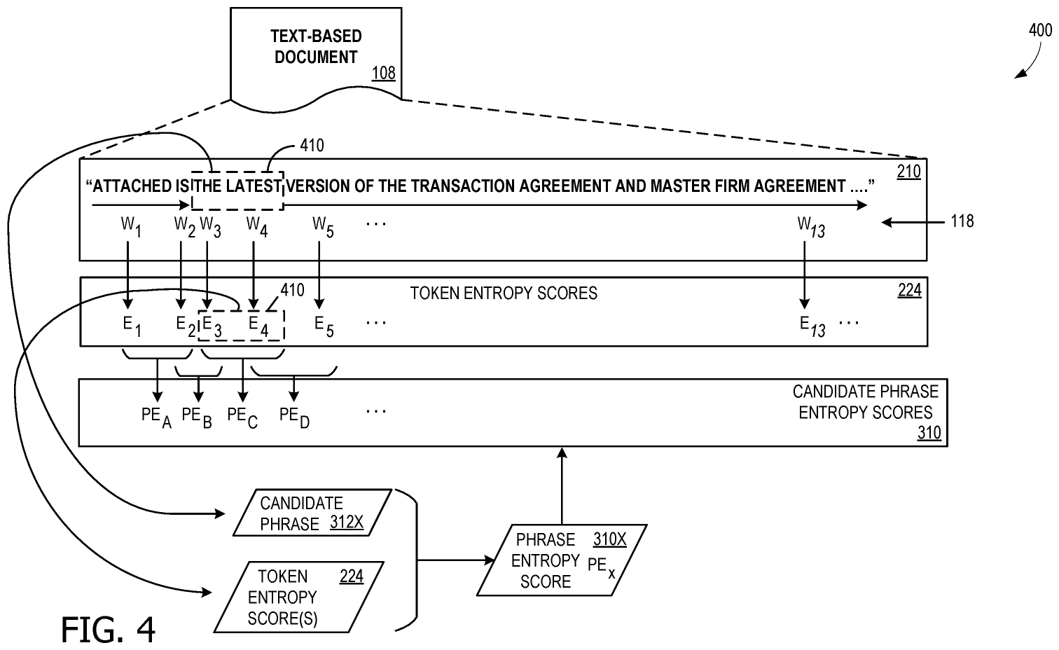

The KP engine 110 also identifies multiple phrases 122 from the subject text and generates an entropy score for each of those phrases 122 (“phrase entropy scores”) based on the token entropy scores of one or more tokens 118 that make up each phrase 122. In the example implementation, the KP engine 110 segments the subject text of the text document 108 based on “stop words,” or words within the natural language that typically do not add much information to the text (e.g., selecting candidate phrases as words appearing between the stop words). Segmentation based on stop words is described in greater detail with respect to FIG. 3 below. In other implementations, the KP engine 110 analyzes the subject text using a sliding window approach (e.g., selecting candidate phrases with a moving window of one or more tokens). The sliding window approach is described in greater detail with respect to FIG. 4. Each phrase 122 selected for entropy scoring may be referred to herein as a “candidate phrase 122,” as the phrase 122 is under consideration for potentially being a “key phrase,” or a phrase of sufficient informativeness (e.g., high entropy) to be included in the key-phrase index 116 for the document 108.

In some implementations, the KP engine 110 provides a user interface (UI) that allows the user 102 to interact with the KP engine 110 for various use cases. For example, the UI allows the user 102 to select particular content items 106 for key-phrase processing, configure settings used for a key-phrase processing job (e.g., user-configured entropy score thresholds, percentages, or the like). The UI may also allow the user 102 to perform operational tasks that utilize preexisting key-phrase indices 116 previously created by the KP engine 110. For example, the UI facilitates document search or clustering based on the key phrases for each document 108. The UI may also provide a CRM system that allows the user 102 to track and work with content involving customer interactions, such as emails, voice mails, conference call recording, or the like.

In some implementations, the KP engine 110 is configured to perform pre-processing on content items 106 before performing key phrase processing. Some content items contain natural language content, but that content may not initially be in text-based form. For example, a voice mail or full motion video includes audio content. As such, the KP engine 110 performs speech-to-text processing on the content item 106 to generate the subject text that will then be analyzed by the KP engine 110 to generate a key-phrase index for the content item 106.

In some implementations, the KP engine 110 automatically performs key phrase processing of documents 108. For example, the KP engine 110 is configured to perform key phrase processing when new documents are added to the content database 104. In such an example, the KP engine 110 automatically identifies key phrases and associated key-phrase index 116 upon receipt of a new document.

FIG. 2 is a dataflow diagram 200 illustrating an example method for generating token entropy scores 224 for each of the tokens (words) 118 of the text document 108 using the architecture 100 shown in FIG. 1. In this example, the text document 108 includes text content 210 that comprises an ordered sequence of words W₁ to Wₙ, where each word, Wₓ, is one of the tokens 118, and where n is the number of words in the text content 210. Here, the text content 210 begins with the sentence fragment “Attached is the latest version of the transaction agreement and master firm agreement . . . ” This subject text illustrates only a portion of the text content 210 of the example document 108 for purposes of illustration, but it should be understood that these methods can be extended to text of any length, as well as ordered or unordered snippets or excerpts of text.

For each particular word, or “next token” 222 (Wₓ), of the text content 210, the KP engine 110 generates and submits a prompt 112 to the LLM 120 for evaluation. The prompt 112 includes some or all of the tokens appearing before the next token 222 within the text content 210. These prior tokens are referred to herein as prefix tokens 220, as they precede the next token 222. In the example implementation, the prefix tokens 220 include all of the tokens 118 in the text content 210 prior to the next token 222, namely tokens W₁ to Wₓ₋₁. In other implementations, the prefix tokens 220 include only some of the preceding tokens 118 (e.g., the preceding five tokens 118, all of the tokens 118 in the current sentence or in the preceding one or more sentences, the tokens 118 in the current paragraph). These prefix tokens 220 are included in the prompt 112, and in the order of their appearance within the text content 210.

During operation, and in response to the prompt 112, the LLM 120 generates a probability distribution 114 for the next token 222. The probability distribution 114 identifies likelihoods of each word in the natural language vocabulary appearing after the prefix tokens 220. The KP engine 110 uses this probability distribution 114 to generate an entropy value or token entropy score 224 (Eₓ) for the next token 222. Given an input prompt such as prompt 112, the LLM 120 is configured to produce this probability distribution 114 of all the words in the vocabulary to be the next word (P(x)). This distribution 114 is used to calculate the token entropy score 224 of the next token 222. In example implementations, an entropy score, H, is calculated as:

$$H = - \sum p ( x ) log ( p ( x ) ) \qquad ( 1 )$$

where p(x) represents a probability of a certain word/token to occur in the current position in the text content 210, where the summation is done over all the possible words/tokens which are in the vocabulary, and where a larger H represents higher entropy for the next token 222. As such, the KP engine 110 generates an entropy score or entropy score 224 for each of the tokens 118 of the subject text 210. In other words, each word, Wₓ, has a token entropy score of Eₓ.

FIG. 3 is a dataflow diagram 300 illustrating an example method for identifying candidate phrases 312 and candidate phrase entropy scores 310 from the text content 210 of text document 108 using stop words. In the example shown here, the subject text content 210 is a portion of text from the text document 108 similar to that shown in FIG. 2. In the example implementation, the KP engine 110 analyzes the text content 210 to identify multiple candidate phrases 312A-312D (collectively, “candidate phrases 312”) using stop words. Stop words are types of words in natural language that typically do not convey much informativeness or impact contextual meaning of the sentence. These stop words include articles, prepositions, conjunctions, or pronouns, and may be preconfigured with other such low-entropy words or phrases.

Such stop word analysis includes identifying stop words within the text content 210, then identifying the words or phrases between such stop words as the candidate phrases 312 for consideration in entropy scoring. In the example shown in FIG. 3, the stop words of the subject text content 210 are shown in italics and include the segments “IS THE”, “OF THE”, and “AND”. Between each of these stop word segments remains several candidate phrases 312, including candidate phrase 312A “ATTACHED”, candidate phrase 312B “LATEST VERSION”, candidate phrase 312C “TRANSACTION AGREEMENT”, and candidate phrase 312D “MASTER FIRM AGREEMENT”, each of which is shown underlined in FIG. 3. In some situations, a candidate phrase 312 is separated into two or more distinct candidate phrases 312 (e.g., when separated by punctuation). For example, consider the example text: “We visited Philadelphia, New York, and Boston during our June trip.” The list of comma-separated cities may be segmented into three distinct candidate phrases 212, one for each city, using the commas as delimiters. As such, the entirety of the subject text 210 is segmented into candidate phrases 312, each of which includes one or more words or tokens 118. These phrases 312 may be similar to the phrases 122 shown in FIG. 1.

For each phrase 312X of the candidate phrases 312, the KP engine 110 determines a candidate phrase entropy score 310X for that phrase 312X based on one or more of the respective token entropy scores 224 for the tokens 118 making up that phrase 312X. In one implementation, the phrase entropy score 310X for the phrase 312X is the token entropy score 224 of the first token 118 of that phrase 312X. For example, with candidate phrase 312B, “LATEST VERSION”, which includes the token entropy scores E₄ and E₅, the candidate phrase entropy score, PE_{B}, is set to E₄, the entropy score of the first word “LATEST” (W₄) in that phrase 312B. In another implementation, the candidate phrase entropy score, PE_{B}, is computed as the average of the token entropy scores 224 of the associated tokens 118. For example, the candidate phrase entropy score, PE_{B}, is computed as (E₄+E₅)/2.

As such, the KP engine 110 computes phrase entropy scores 310 for each of the candidate phrases 312. In this example, because the “ATTACHED” candidate phrase 312A and the “LATEST VERSION” candidate phrase 312B are relatively common words or phrases in the English language, these candidate phrases 312A, 312B may yield moderate entropy scores (e.g., values of 2.28 and 4.56, respectively), and are thus less likely to be included in the key-phrase index 116. On the other hand, since the “TRANSACTION AGREEMENT” candidate phrase 312C and the “MASTER FIRM AGREEMENT” candidate phrase 312D are fairly uncommon phrases, these candidate phrases 312C, 312D may yield higher entropy scores (e.g., values of 11.92 and 9.42, respectively), and thus are more likely to be included in the key-phrase index 116.

The KP engine 110 uses these entropy scores 310 to create the key-phrase index 116 for the document 108. In some implementations, the KP engine 110 includes all candidate phrases 312 having entropy scores 310 over a predetermined threshold in the key-phrase index 116 (e.g., all candidate phrases 312 having H>5.0). In some implementations, the KP engine 110 includes a predetermined percentage of candidate phrases 312 in the key-phrase index 116 (e.g., the top 20% of candidate phrases 312) or a predetermined number of candidate phrases 312 in the key-phrase index 116 (e.g., the top five candidate phrases 312). In some implementations, the key-phrase index 116 includes some or all of the candidate phrases 312 as well as their associated entropy scores 310, and these entropy scores 310 are used during particular use cases, such as, for example, a tailored key phrase-oriented document search or document clustering (e.g., identifying documents with key phrases exceeding a custom entropy threshold, weighting documents in search results based on entropy values of search terms), summarizing documents such as scientific articles, or capturing information about brands or companies from product or technical documents, advertising or marketing materials, or the like. The key-phrase index 116 may be stored as a list of metadata linked to the particular document 108, as a database index in the content database 104, or the like.

FIG. 4 is a dataflow diagram 400 illustrating another example method for identifying candidate phrases 312 and candidate phrase entropy scores 310 from the text 210 of text document 108 using a sliding window approach. In the example implementation, the KP engine 110 defines a sliding window 410 having a window size of two tokens 118, but other window sizes are possible.

During operation, the sliding window 410 is moved along the subject text 210 during analysis (e.g., moving one token 118 at a time to the right), and the tokens 118 appearing within the sliding window 410 are used as the candidate phrase 312X at each iteration. As shown in FIG. 4, the sliding window 410 currently includes the tokens W₃ and W₄ (the phrase “THE LATEST”). The window 410 also identifies the associated token entropy scores 224 (E₃ and E₄). Similar to the implementations discussed above in relation to FIG. 3, the KP engine 110 may use the token entropy score 224 of the first token 118 of the candidate phrase 312X to determine the phrase entropy score 310X (PEₓ) (e.g., PE_{C}=E₃), or the KP engine 110 may compute an average of the token entropy scores 224 of the candidate phrase 312X as identified by the window 410 to use as the phrase entropy score 310X (PEₓ) (e.g., PE_{C}=(E₃+E₄)/2).

Similarly, and as shown in FIG. 4, the candidate phrase entropy score PE_{A} is determined from token entropy scores E₁ and E₂, the candidate phrase entropy score PE_{B} is determined from token entropy scores E₂ and E₃, the candidate phrase entropy score PE_{D} is determined from token entropy scores E₄ and E₅, and so forth.

In the example implementation, the KP engine 110 is configured with a static window size (e.g., a fixed size of two tokens). In some implementations, the KP engine 110 is configured to perform multiple key phrase analysis passes through the text 210. For example, the KP engine 110 is configured to perform a first pass with a fixed window size of two words, a second pass with a fixed window size of three words, and perhaps a third or more passes with greater fixed window sizes. In such implementations, the KP engine 110 selects one-, two-, or more-word candidate phrases 312 for inclusion in the key-phrase index 116 (e.g., from the one-token phrases (Wₓ) using the token entropy scores 224 (Eₓ), from the two-token candidate phrases 312 using the candidate phrase entropy scores 310 (PEₓ), and possibly from three-or-more-token candidate phrases).

In some implementations, the KP engine 110 uses other known key-phrase extraction algorithms to identify candidate phrases 312, either in conjunction with, or in lieu of, the stop word or sliding window algorithms shown in FIG. 3 and FIG. 4, respectively. For example, the KP engine 110 uses RAKE or KeyBERT to identify candidate phrases 312, and then creates prompts 112 for submission to the LLM 120 and perform entropy scoring on those phrases 312 via any of the methods described herein.

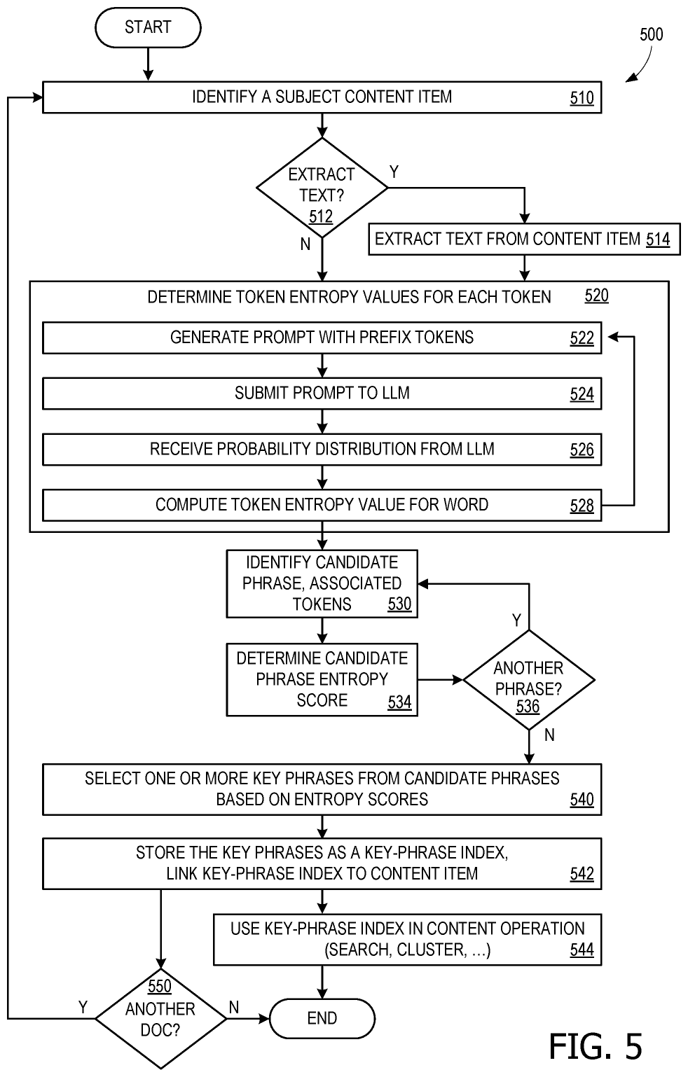

FIG. 5 is a flowchart 500 illustrating exemplary operations that may be performed by architecture 100 for providing key-phrase extraction and entropy evaluation of key phrases 312. In the example implementation, the operations of flowchart 500 are performed by the KP engine 110 using the LLM 120 of FIG. 1. The content items 106 can be any type of digital content that contains natural language content, such as documents, audio, video, or the like. At operation 510, the KP engine 110 identifies a subject content item 106, such as document 108.

In some situations, the subject content item 106 contains native text content (e.g., text content 210) that can be directly evaluated by the KP engine 110. In some situations, the content item 106 contains text content, but the text content may not be directly usable. For example, text content 210 is extracted from a word processing document, optical character recognition (OCR) content embedded in a PDF document, or web page content embedded within tags of a web page. In some situations, the content item 106 contains natural language content embedded in some non-text-based form, such as audio content of a voice mail message or recorded meeting. If, at decision operation 512, the content item 106 has embedded text that needs pre-processing operations to extract the embedded text, then the KP engine 110 performs pre-processing operations to extract the embedded text from the content item at operation 514 (e.g., thereby extracting text content 210). For example, the KP engine 110 performs OCR on a PDF document, speech-to-text processing of audio-based content, or parsing of web content, or any such operation that can extract natural language content from particular media types and convert to simple text format.

At operation 520, the KP engine 110 determines a token entropy score 224 for each token 118 (e.g., next token 222) in the text content 210. The entropy scoring of operation 520 includes generating a prompt 112 for the next token 222 at operation 522, where the prompt 112 includes prefix tokens 220. At operation 524, the KP engine 110 submits the prompt 112 as input to the LLM 120, thereby causing the LLM 120 to evaluate the prefix tokens 220 and generate a probability distribution 114. At operation 526, the KP engine 110 receives the probability distribution 114 and computes a token entropy score 224 for the next token 222 based on the probability distribution 114 at operation 528. This entropy scoring operation 520 is performed for each token 118 in the text content 210.

At operation 530, the KP engine 110 identifies a candidate phrase 312 from the text content 210. The candidate phrase 312 includes one or more tokens that are identified, for example, using the stop word approach described in FIG. 3, or using the sliding window approach described in FIG. 4. At operation 534, the KP engine 110 determines a candidate phrase entropy score 310 based on the token entropy scores 224 of the tokens 118 associated with the candidate phrase 312. In some implementations, the candidate phrase entropy score 310 is set to the entropy score of the first token 118 of the candidate phrase 312. In other implementations, the candidate phrase entropy score 310 is computed as the average of the token entropy scores 224 of the tokens 118 associated with the current candidate phrase 312. At decision operation 536, if there is another candidate phrase 312 to evaluate, the KP engine 110 returns to operation 530. In sliding window implementations, this may include moving the sliding window 410. In multiple pass implementations, this may include initiating another pass through the text content 210 (e.g., with a different window size, an additional candidate phrase selection algorithm, or the like).

At operation 540, the KP engine 110 selects one or more key phrases from the various candidate phrases 312 based on their associated entropy scores. Operation 540 includes any of the phrase selection techniques described herein, such as comparing entropy scores to threshold values or percentages and selecting a particular number or percentage of the highest entropy phrases 312. At operation 542, the selected key phrases are stored as a key-phrase index that is linked or otherwise associated with the content item 106 being evaluated. If, at decision operation 550, there is another content item 106 or document 108 to analyze, the KP engine 110 returns to operation 510. Otherwise, the current key-phrase extraction operations are concluded. At operation 544, the KP engine 110 uses the key-phrase indices of the processed content items 106 for content operations such as search, clustering, or the like. In some implementations, the key phrases may be displayed to the user 102 to allow the user 102 to identify what the content item 106 is about, see the main topics of the content item 106, the concepts in the content item 106, or the like.

### Additional Examples

In some examples, the entropy evaluation techniques described herein are able to identify key phrases not able to be identified by some other known methods, and thus provide an improvement in a technical field by using language probability techniques.

An example system comprises: a processor; and a computer-readable medium storing instructions that are operative upon execution by the processor to: identify a content item comprising text content; determine a token entropy score for a first token of the content item by: generating and submitting a prompt to a large language model (LLM), the prompt including a prefix token preceding the first token of the text content; receiving a probability distribution from the LLM in response to the prompt; and generating a token entropy score for the first token; identify a candidate phrase within the text content, the candidate phrase including a first token, the first token having an associated token entropy score; compute a phrase entropy score for the candidate phrase based on the token entropy score of the first token; store the candidate phrase as a key phrase of the content item upon the phrase entropy score exceeding a threshold; and search a database of content items based on the key phrase, the search returning results including the content item.

An example method comprises: identifying a content item comprising text content; determining a token entropy score for a first token of the content item by: generating and submitting a prompt to a large language model (LLM), the prompt including a prefix token preceding the first token of the text content; receiving a probability distribution from the LLM in response to the prompt; and generating a token entropy score for the first token; identifying a candidate phrase within the text content, the candidate phrase including a first token, the first token having an associated token entropy score; computing a phrase entropy score for the candidate phrase based on the token entropy score of the first token; storing the candidate phrase as a key phrase of the content item upon the phrase entropy score exceeding a threshold; and searching a database of content items based on the key phrase, the search returning results including the content item.

One or more example computer storage devices have computer-executable instructions stored thereon, which, on execution by a computer, cause the computer to perform operations comprising: identifying a content item comprising text content; determining a token entropy score for a first token of the content item by: generating and submitting a prompt to a large language model (LLM), the prompt including a prefix token preceding the first token of the text content; receiving a probability distribution from the LLM in response to the prompt; and generating a token entropy score for the first token; identifying a candidate phrase within the text content, the candidate phrase including a first token, the first token having an associated token entropy score; computing a phrase entropy score for the candidate phrase based on the token entropy score of the first token; storing the candidate phrase as a key phrase of the content item upon the phrase entropy score exceeding a threshold; and searching a database of content items based on the key phrase, the search returning results including the content item.

Alternatively, or in addition to the other examples described herein, examples include any combination of the following:
displaying a user interface (UI);
parse text content of the content item using a sliding window;
use a sliding window that includes a portion of next tokens;
use a sliding window that includes a portion of prefix tokens;
use a sliding window that includes a window size defining a fixed number of words to include in the next segment of the prompt;
performing multiple parsings of text content of a content item using different settings for each parsing;
a parsing using a sliding window that includes a window size defining a different fixed number of words to include in the next segment of a prompt;
parsing text content of a content item by excluding stop words from the next segment of the prompt;
stop words include articles, prepositions, conjunctions, and pronouns;
a prefix segment includes one or more words appearing immediately before the next segment in the text content of the content item;
a prefix segment includes zero words;
a prefix segment is empty;
generating a key-phrase index for the content item that includes multiple key phrases that have entropy scores above a predetermined threshold;
searching documents using a key-phrase index;
calculating entropy scores using probability output from an LLM;
extracting text from content items using speech-to-text functions;
extracting text from content items using OCR;
extracting text from content items by parsing simple text out of complex documents;
searching documents using a key-phrase index;
clustering documents using a key-phrase index;
annotating documents using a key-phrase index;
a database of content items includes content items associated with customer relationship management, including content items associated with one or more of customer communications and documentation of customer interactions;
selecting key phrases from a set of candidate phrases based on entropy scores;
search a database of content items based on the key phrase, search return results including the content item;
identifying a content item comprising text content;
determining token entropy scores for one or more tokens of the content item;
generating and submitting a prompt to a large language model (LLM), the prompt including one or more prefix tokens preceding a next token of the text content;
receiving a probability distribution from the LLM in response to the prompt; and
generating a token entropy score for the next token;
identifying a candidate phrase within the text content, the candidate phrase including one or more tokens, each token of the one or more tokens having an associated token entropy score;
computing a phrase entropy score for the candidate phrase based on the token entropy scores of the one or more tokens;
storing the candidate phrase as a key phrase of the content item upon the phrase entropy score exceeding a threshold;
searching a database of content items based on the key phrase, the search returning results including the content item;
identifying a candidate phrase within the text content includes parsing the text content of the content item using a first sliding window, the first sliding window includes a first window size defining a first fixed number of words to include in the candidate phrase;
performing a second parsing of the text content of the content item using a second sliding window that includes a second window size defining a second fixed number of words to include in the candidate phrase, the second fixed number of words being different from the first fixed number of words;
identifying a candidate phrase within the text content includes parsing text content of the content item by excluding a stop word from the text content when identifying the candidate phrase;
one or more prefix tokens includes a word appearing immediately before the next token within the text content of the content item;
generating a key-phrase index for the content item that includes multiple key phrases that have entropy scores exceeding the threshold; and
a database of content items includes content items associated with customer relationship management, including content items associated with one or more of customer communications and documentation of customer interactions.

While the aspects of the disclosure have been described in terms of various examples with their associated operations, a person skilled in the art would appreciate that a combination of operations from any number of different examples is also within scope of the aspects of the disclosure.

### Example Operating Environment

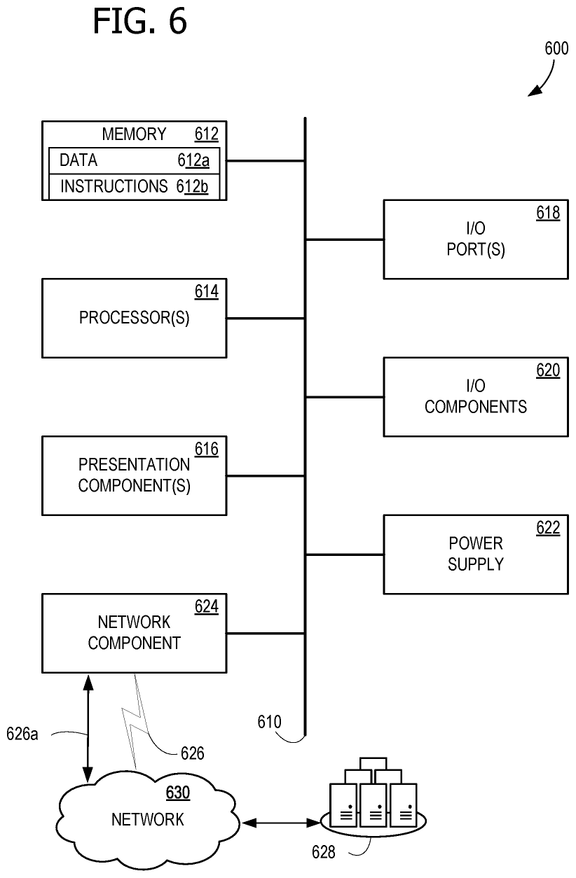

FIG. 6 is a block diagram of an example computing device 600 (e.g., a computer storage device) for implementing aspects disclosed herein, and is designated generally as computing device 600. In some examples, one or more computing devices 600 are provided for an on-premises computing solution. In some examples, one or more computing devices 600 are provided as a cloud computing solution. In some examples, a combination of on-premises and cloud computing solutions are used. Computing device 600 is but one example of a suitable computing environment and is not intended to suggest any limitation as to the scope of use or functionality of the examples disclosed herein, whether used singly or as part of a larger set. Neither should computing device 600 be interpreted as having any dependency or requirement relating to any one or combination of components/modules illustrated.

The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 600 includes a bus 610 that directly or indirectly couples the following devices: computer storage memory 612, one or more processors 614, one or more presentation components 616, input/output (I/O) ports 618, I/O components 620, a power supply 622, and a network component 624. While computing device 600 is depicted as a seemingly single device, multiple computing devices 600 may work together and share the depicted device resources. For example, memory 612 may be distributed across multiple devices, and processor(s) 614 may be housed with different devices.

Bus 610 represents what may be one or more busses (such as an address bus, data bus, or a combination thereof). Although the various blocks of FIG. 6 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 6 and the references herein to a “computing device.” Memory 612 may take the form of the computer storage media referenced below and operatively provide storage of computer-readable instructions, data structures, program modules and other data for the computing device 600. In some examples, memory 612 stores one or more of an operating system, a universal application platform, or other program modules and program data. Memory 612 is thus able to store and access data 612a and instructions 612b that are executable by processor 614 and configured to carry out the various operations disclosed herein.

In some examples, memory 612 includes computer storage media. Memory 612 may include any quantity of memory associated with or accessible by the computing device 600. Memory 612 may be internal to the computing device 600 (as shown in FIG. 6), external to the computing device 600 (not shown), or both (not shown). Additionally, or alternatively, the memory 612 may be distributed across multiple computing devices 600, for example, in a virtualized environment in which instruction processing is carried out on multiple computing devices 600. For the purposes of this disclosure, “computer storage media,” “computer-storage memory,” “memory,” and “memory devices” are synonymous terms for the computer-storage memory 612, and none of these terms include carrier waves or propagating signaling.

Processor(s) 614 may include any quantity of processing units that read data from various entities, such as memory 612 or I/O components 620. Specifically, processor(s) 614 are programmed to execute computer-executable instructions for implementing aspects of the disclosure. The instructions may be performed by the processor, by multiple processors within the computing device 600, or by a processor external to the client computing device 600. In some examples, the processor(s) 614 are programmed to execute instructions such as those illustrated in the flow charts discussed below and depicted in the accompanying drawings. Moreover, in some examples, the processor(s) 614 represent an implementation of analog techniques to perform the operations described herein. For example, the operations may be performed by an analog client computing device 600 and/or a digital client computing device 600. Presentation component(s) 616 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 600, across a wired connection, or in other ways. I/O ports 618 allow computing device 600 to be logically coupled to other devices including I/O components 620, some of which may be built in. Example I/O components 620 include, for example but without limitation, a microphone, joystick, game pad, satellite dish, scanner, printer, wireless device, etc.

Computing device 600 may operate in a networked environment via the network component 624 using logical connections to one or more remote computers. In some examples, the network component 624 includes a network interface card and/or computer-executable instructions (e.g., a driver) for operating the network interface card. Communication between the computing device 600 and other devices may occur using any protocol or mechanism over any wired or wireless connection. In some examples, network component 624 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 624 communicates over wireless communication link 626 and/or a wired communication link 626a to a remote resource 628 (e.g., a cloud resource) across network 630. Various different examples of communication links 626 and 626a include a wireless connection, a wired connection, and/or a dedicated link, and in some examples, at least a portion is routed through the internet.

Although described in connection with an example computing device 600, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
identify a content item comprising text content;
determine a token entropy score for a first token of the content item including:
generating and submitting a prompt to a large language model (LLM), the prompt including a prefix token preceding the first token of the text content;
receiving a probability distribution from the LLM in response to the prompt; and
generating the token entropy score for the first token;
identify a candidate phrase within the text content, the candidate phrase including the first token;
compute a phrase entropy score for the candidate phrase based on the token entropy score of the first token;
store the candidate phrase as a key phrase of the content item upon the phrase entropy score exceeding a threshold; and
search a database of content items based on the key phrase, the search returning results including the content item.

2. The system of claim 1, wherein identifying a candidate phrase within the text content includes parsing the text content of the content item using a first sliding window, the first sliding window includes a first window size defining a first fixed number of words to include in the candidate phrase.

3. The system of claim 2, wherein the instructions are further operative to perform a second parsing of the text content of the content item using a second sliding window that includes a second window size defining a second fixed number of words to include in the candidate phrase, the second fixed number of words being different from the first fixed number of words.

4. The system of claim 1, wherein identifying a candidate phrase within the text content includes parsing text content of the content item by excluding a stop word from the text content when identifying the candidate phrase.

5. The system of claim 1, wherein the prefix token includes a word appearing immediately before the first token within the text content of the content item.

6. The system of claim 1, wherein the instructions are further operative to generate a key-phrase index for the content item that includes multiple key phrases that have entropy scores exceeding the threshold.

7. The system of claim 1, wherein the database of content items includes content items associated with customer relationship management, including content items associated with one or more of: customer communications and documentation of customer interactions.

8. A computer-implemented method comprising:
identifying a content item comprising text content;
determining a token entropy score for a first token of the content item by:
generating and submitting a prompt to a large language model (LLM), the prompt including a prefix token preceding the first token of the text content;
receiving a probability distribution from the LLM in response to the prompt; and
generating the token entropy score for the first token;
identifying a candidate phrase within the text content, the candidate phrase including the first token;
computing a phrase entropy score for the candidate phrase based on the token entropy score of the first token;
storing the candidate phrase as a key phrase of the content item upon the phrase entropy score exceeding a threshold; and
searching a database of content items based on the key phrase, the search returning results including the content item.

9. The method of claim 8, wherein identifying a candidate phrase within the text content includes parsing the text content of the content item using a first sliding window, the first sliding window includes a first window size defining a first fixed number of words to include in the candidate phrase.

10. The method of claim 9, further comprising performing a second parsing of the text content of the content item using a second sliding window that includes a second window size defining a second fixed number of words to include in the candidate phrase, the second fixed number of words being different from the first fixed number of words.

11. The method of claim 8, wherein identifying a candidate phrase within the text content includes parsing text content of the content item by excluding a stop word from the text content when identifying the candidate phrase.

12. The method of claim 8, wherein the prefix token includes a word appearing immediately before the first token within the text content of the content item.

13. The method of claim 8, further comprising generating a key-phrase index for the content item that includes multiple key phrases that have entropy scores exceeding the threshold.

14. The method of claim 8, wherein the database of content items includes content items associated with customer relationship management, including content items associated with one or more of: customer communications and documentation of customer interactions.

15. A computer storage device having computer-executable instructions stored thereon, which, on execution by a computer, cause the computer to perform operations comprising:
identifying a content item comprising text content;
determining a token entropy score for a first token of the content item by:
generating and submitting a prompt to a large language model (LLM), the prompt including a prefix token preceding the first token of the text content;
receiving a probability distribution from the LLM in response to the prompt; and
generating the token entropy score for the first token;
identifying a candidate phrase within the text content, the candidate phrase including a first token;
computing a phrase entropy score for the candidate phrase based on the token entropy score of the first token;
storing the candidate phrase as a key phrase of the content item upon the phrase entropy score exceeding a threshold; and
searching a database of content items based on the key phrase, the search returning results including the content item.

16. The computer storage device of claim 15, wherein identifying a candidate phrase within the text content includes parsing the text content of the content item using a first sliding window, the first sliding window includes a first window size defining a first fixed number of words to include in the candidate phrase.

17. The computer storage device of claim 16, further comprising performing a second parsing of the text content of the content item using a second sliding window that includes a second window size defining a second fixed number of words to include in the candidate phrase, the second fixed number of words being different from the first fixed number of words.

18. The computer storage device of claim 15, wherein identifying a candidate phrase within the text content includes parsing text content of the content item by excluding a stop word from the text content when identifying the candidate phrase.

19. The computer storage device of claim 15, the operations further comprising generating a key-phrase index for the content item that includes multiple key phrases that have entropy scores exceeding the threshold.

20. The computer storage device of claim 15, wherein the database of content items includes content items associated with customer relationship management, including content items associated with one or more of: customer communications and documentation of customer interactions.
